(19) United States
(12) Patent Application Publication
(10) Pub. No.: US 2026/0251159 A1
(43) Pub. Date: Aug. 27, 2026

(54) Muffler for Noise Reduction of Heat Dissipation Fan in Computer System

(71) Applicant: Celanese Mercury Holdings Inc., Wilmington, DE (US)

(72) Inventors: Xu Han, Shanghai (CN); Shangyu Chen, Tianjin (CN); Yifan Xu, Shanghai (CN)

(21) Appl. No.: 19/115,275

(22) PCT Filed: Aug. 24, 2023
(86) PCT No.: PCT/CN2023/114687

§ 371 Date: Mar. 26, 2025

(51) Int. Cl. F04D 29/66; G06F 1/20

(52) U.S. Cl. CPC F04D 29/665; G06F 1/20

(57) ABSTRACT

A computer system comprising a chassis containing at least one heat-generating computing component, at least one heat dissipating fan contained within the chassis configured to convectively cool the at least one heat-generating computing component, and at least one muffler positioned at an inlet or outlet of the at least one heat dissipating fan. The at least one muffler comprises an inlet, an outlet, a main duct extending between the inlet and the outlet, at least one resonance chamber peripherally surrounding the main duct, and a plurality of apertures in the main duct configured to allow air and sound to flow and transfer between the main duct and the at least one resonance chamber.

### BACKGROUND OF THE INVENTION

With the rapid development of information technology, individuals and businesses seek more ways to process and store information. Computer systems (e.g., servers), as information processing systems, are usually used for commercial, personal, or other purposes to process, compile, store, and/or transmit information or data. Security and reliability of such data storage and transmission is important. As the scale and speed of data storage and transmission continue to increase, computer systems integrate more electrical devices and components internally, consuming more power and generating more heat. When the temperature increases due to the increased heat, it affects the efficiency and reliability of the computer system. Therefore, high-speed heat dissipation fans are typically used to reduce the temperature inside the computer system.

However, high-speed heat dissipation fans not only move more air for heat dissipation but also generate more noise in the system, which can reduce the input/output accuracy of hard disks within the system, thereby affecting the reliability of the overall system. Moreover, as storage capacities and transmission speeds of hard disks continue to increase, the sensitivity of the hard disks to noise will also increase exponentially. Therefore, reducing the noise of heat dissipation fans is key to ensuring the reliability of hard disk storage and transmission. As such, there is a need for a computer system having reduced noise from heat dissipation fans while also providing adequate cooling.

### SUMMARY OF THE INVENTION

In accordance with one embodiment, a computer system is disclosed. The computer system comprises a chassis containing at least one heat-generating computing component, at least one heat dissipating fan contained within the chassis configured to convectively cool the at least one heat-generating computing component, and at least one muffler positioned at an inlet or outlet of the at least one heat dissipating fan. The at least one muffler comprises an inlet, an outlet, a main duct extending between the inlet and the outlet, at least one resonance chamber peripherally surrounding the main duct, and a plurality of apertures in the main duct configured to allow air to flow between the main duct and the at least one resonance chamber.

In accordance with another embodiment, a process for reducing the noise of a heat dissipation fan within a computer system is disclosed. The process comprises obtaining a target value for noise reduction within at least one frequency band, determining a maximum cross-sectional area and a maximum length for a muffler, designing the muffler based on the target value for noise reduction and the maximum cross-sectional area and maximum length, and positioning the muffler at an inlet or outlet of the heat dissipation fan. The muffler comprises an inlet, an outlet, a main duct extending between the inlet and the outlet, at least one resonance chamber peripherally surrounding the main duct, and a plurality of apertures in the main duct configured to allow air to flow between the main duct and the at least one resonance chamber.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 illustrates a cross-sectional view of a muffler in accordance with the present disclosure;

FIG. 2 illustrates a transparent view of a muffler in accordance with the present disclosure;

FIG. 3 illustrates a perspective view of a set of mufflers integrally attached in accordance with the present disclosure;

FIG. 4 illustrates a computer server system;

FIG. 5 illustrates a computer system including a set of mufflers in accordance with the present disclosure;

FIG. 6 illustrates an exemplary target sound transmission loss curve; and

FIG. 7 is a diagram illustrating the maximum length and cross-sectional area for a muffler design.

FIG. 8 is an acceleration curve obtained from a cantilever beam vibration test of two polymer compositions.

### DETAILED DESCRIPTION

It is to be understood by one of ordinary skill in the art that the present discussion is a description of exemplary embodiments only and is not intended as limiting the broader aspects of the present invention.

Generally speaking, the present invention is directed to a computer system containing a muffler to reduce noise generated by a heat dissipation fan. The computer system (e.g., a server) comprises a chassis (e.g., a server rack) which contains computing components which generate heat. As part of a cooling system for the computing components, at least one heat dissipating fan is also contained in the chassis. The heat dissipating fan can blow air in the direction of the computing components or can blow air away from the computing components, thereby exhausting the heated air. In either configuration, a muffler is positioned in the interior of the chassis to reduce the noise level (i.e., sound pressure) at the computing components, which may contain a hard drive disk (HDD) which is sensitive to noise. By reducing the noise at an HDD, the HDD can operate faster and more accurately, which in turn makes the computer system faster and more accurate.

Advantageously, the muffler can be customized for each specific computer system. For example, its shape can be designed to fit within a specific chassis to avoid interference with any computing components or any other structures. Additionally, the internal structure of the muffler can be tailored to provide a specified sound transmission loss within a given frequency band. As such, the muffler can be designed for the specific needs of a particular computer system.

The use of such a muffler can dramatically improve the performance of an HDD within the system. For example, in some embodiments, the input/output operations per second (IOPS) of an HDD can be increased by about 10% or more, in some embodiments about 30% or more, in some embodiments about 50% or more, and in some embodiments from about 70% to about 100%, compared to the same system not including the muffler.

In some embodiments, the muffler can reduce the sound pressure within the chassis by at least about 10 dB, in some embodiments about 15 dB, and in some embodiments, about 20 dB at a frequency between 1,500 and 10,000 Hz.

The muffler may be made from a variety of different materials, including metals and polymers. In some preferred embodiments, the muffler comprises a polymer composition containing a polymer matrix. Any of a variety of polymers or combinations of polymers may generally be employed in the polymer matrix. For example, the polymer may be semi-crystalline or crystalline in nature. In one embodiment, the polymer may be semi-crystalline. In another embodiment, the polymer may be crystalline. In addition, in one embodiment, the polymer may be an aromatic polymer. Alternatively, in another embodiment, the polymer may be an aliphatic polymer.

Suitable polymers may include thermoplastic polymers. For example, these polymers may include polyolefins (e.g., ethylene polymers, propylene polymers, etc.), polyamides (e.g., aliphatic, semi-aromatic, or aromatic polyamides), polyesters (e.g., polyethylene terephthalate, polybutylene terephthalate, liquid crystalline polymers), polyarylene sulfides, polyetherimides, polyacetals (e.g., polyoxymethylene), polyphenylene oxides, polyarylketones (e.g., polyetheretherketone, polyetherketoneketone, etc.), polycarbonates, etc., as well as blends thereof.

Regardless, the polymers may be generally considered “high-performance” polymers such that they have a relatively high glass transition temperature and/or high melting temperature. Such high-performance polymers can thus provide a substantial degree of heat resistance to the polymer composition. For example, the polymer may have a glass transition temperature of about 30° C. or more, in some embodiments about 40° C. or more, in some embodiments from about 50° C. to about 250° C., in some embodiments from about 60° C. to about 150° C. The polymer may also have a melting temperature of about 180° C. or more, in some embodiments about 200° C. or more, in some embodiments from about 210° C. to about 400° C., in some embodiments from about 220° C. to about 380° C. The glass transition and melting temperatures may be determined as is well known in the art using differential scanning calorimetry (“DSC”), such as determined by ISO Test No. 11357-2:2013 (glass transition) and 11357-3:2011 (melting).

One example of a suitable semi-crystalline polymer may be a polyamide. For instance, the polyamide may be an aromatic polyamide in one embodiment. In this regard, the aromatic polyamide may have a relatively high melting temperature, such as about 200° C. or more, in some embodiments about 220° C. or more, and in some embodiments from about 240° C. to about 320° C., as determined using differential scanning calorimetry according to ISO Test No. 11357. The glass transition temperature of aromatic polyamides is likewise generally from about 110° C. to about 160° C. In another embodiment, the polyamide may be an aliphatic polyamide. In this regard, the aliphatic polyamide may also have a relatively high melting temperature, such as about 180° C. or more, in some embodiments about 200° C. or more, and in some embodiments from about 210° C. to about 320° C., as determined using differential scanning calorimetry according to ISO Test No. 11357. The glass transition temperature of the aliphatic polyamides is likewise generally from about 30° C. to about 170° C.

Aromatic polyamides typically contain repeating units held together by amide linkages (NH—CO) and are synthesized through the polycondensation of dicarboxylic acids (e.g., aromatic dicarboxylic acids), diamines (e.g., aliphatic diamines), etc. For example, the aromatic polyamide may contain aromatic repeating units derived from an aromatic dicarboxylic acid, such as terephthalic acid, isophthalic acid, 2,6-naphthalenedicarboxylic acid, 2,7-naphthalenedicarboxylic acid, 1,4-naphthalenedicarboxylic acid, 1,4-phenylenedioxy-diacetic acid, 1,3-phenylenedioxy-diacetic acid, diphenic acid, 4,4′-oxydibenzoic acid, diphenylmethane-4,4′-dicarboxylic acid, diphenylsulfone-4,4′-dicarboxylic acid, 4,4′-biphenyldicarboxylic acid, etc., as well as combinations thereof. Terephthalic acid is particularly suitable. Of course, it should also be understood that other types of acid units may also be employed, such as aliphatic dicarboxylic acid units, polyfunctional carboxylic acid units, etc.

Aliphatic polyamides also typically contain repeating units held together by amide linkages (NH—CO). These polyamides can be synthesized through various techniques. For example, the polyamide may be formed by a ring-opening polymerization, such as a ring-opening polymerization of caprolactam. These polyamides may also be synthesized through the polycondensation of dicarboxylic acids (e.g., aliphatic dicarboxylic acids), diamines, etc. For example, the aromatic polyamide may contain aliphatic repeating units derived from an aliphatic dicarboxylic acid, such as adipic acid, suberic acid, azelaic acid, sebacic acid, undecanedioic acid, dodecanedioic acid, brassylic acid, tetradecanedioic acid, pentadecanedioic acid, hexadecanedioic acid, octadecanedioic acid, dimeric acid, the cis- and/or trans-cyclohexane-1,4-dicarboxylic acid, the cis- and/or trans-cyclohexane-1,3-dicarboxylic acid, etc. as well as combinations thereof. Adipic acid is particularly suitable.

The polyamide may also contain aliphatic repeating units derived from an aliphatic diamine, which typically has from 4 to 14 carbon atoms. Examples of such diamines include linear aliphatic alkylenediamines, such as 1,4-tetramethylenediamine, 1,6-hexanediamine, 1,7-heptanediamine, 1,8-octanediamine, 1,9-nonanediamine, 1,10-decanediamine, 1,11-undecanediamine, 1,12-dodecanediamine, etc.; branched aliphatic alkylenediamines, such as 2-methyl-1,5-pentanediamine, 3-methyl-1,5 pentanediamine, 2,2,4-trimethyl-1,6-hexanediamine, 2,4,4-trimethyl-1,6-hexanediamine, 2,4-dimethyl-1,6-hexanediamine, 2-methyl-1,8-octanediamine, 5-methyl-1,9-nonanediamine, etc.; as well as combinations thereof. Repeating units derived from 1,9-nonanediamine and/or 2-methyl-1,8-octanediamine are particularly suitable. Of course, other diamine units may also be employed, such as alicyclic diamines, aromatic diamines, etc.

Particularly suitable aromatic polyamides may include poly(nonamethylene terephthalamide) (PA9T), poly(nonamethylene terephthalamide/nonamethylene decanediamide) (PA9T/910), poly(nonamethylene terephthalamide/nonamethylene dodecanediamide) (PA9T/912), poly(nonamethylene terephthalamide/11-aminoundecanamide) (PA9T/11), poly(nonamethylene terephthalamide/12-aminododecanamide) (PA9T/12), poly(decamethylene terephthalamide/11-aminoundecanamide) (PA 10T/11), poly(decamethylene terephthalamide/12-aminododecanamide) (PA10T/12), poly(decamethylene terephthalamide/decamethylene decanediamide) (PA10T/1010), poly(decamethylene terephthalamide/decamethylene dodecanediamide) (PA10T/1012), poly(decamethylene terephthalamide/tetramethylene hexanediamide) (PA10T/46), poly(decamethylene terephthalamide/caprolactam) (PA10T/6), poly(decamethylene terephthalamide/hexamethylene hexanediamide) (PA10T/66), poly(dodecamethylene terephthalamide/dodecamethylene dodecanediamide) (PA12T/1212), poly(dodecamethylene terephthalamide/caprolactam) (PA12T/6), poly(dodecamethylene terephthalamide/hexamethylene hexanediamide) (PA12T/66), polyphthalamide (PPA), and so forth. Particularly suitable aliphatic polyamides may include polyamide 4,6, polyamide 5,10, polyamide 6, polyamide 6,6, polyamide 6,9, polyamide 6,10, polyamide 6,12, polyamide 11, polyamide 12, and so forth. Yet other examples of suitable aromatic polyamides are described in U.S. Pat. No. 8,324,307 to Harder, et al.

Another suitable semi-crystalline aromatic polymer is an aromatic polyester that is a condensation product of an aromatic dicarboxylic acid having 8 to 14 carbon atoms and at least one diol. Suitable diols may include, for instance, neopentyl glycol, cyclohexanedimethanol, 2,2-dimethyl-1,3-propane diol and aliphatic glycols of the formula HO(CH₂)ₙOH where n is an integer of 2 to 10. Suitable aromatic dicarboxylic acids may include, for instance, isophthalic acid, terephthalic acid, 1,2-di(p-carboxyphenyl)ethane, 4,4′-dicarboxydiphenyl ether, etc., as well as combinations thereof. Fused rings can also be present such as in 1,4- or 1,5- or 2,6-naphthalene-dicarboxylic acids. Particular examples of such aromatic polyesters may include, for instance, poly(ethylene terephthalate) (PET), poly(1,4-butylene terephthalate) (PBT), poly(1,3-propylene terephthalate) (PPT), poly(1,4-butylene 2,6-naphthalate) (PBN), poly(ethylene 2,6-naphthalate) (PEN), poly(1,4-cyclohexylene dimethylene terephthalate) (PCT), and copolymers and mixtures of the foregoing.

Polyarylene sulfides are also suitable semi-crystalline aromatic polymers. The polyarylene sulfide(s) employed in the composition generally have repeating units of the formula:

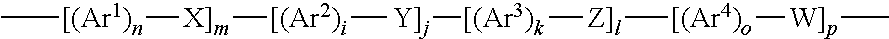

wherein,
   Ar¹, Ar², Ar³, and Ar^{H} are independently arylene units of 6 to 18 carbon atoms;
   W, X, Y, and Z are independently bivalent linking groups selected from —SO₂—, —S—, —SO—, —CO—, —O—, —C(O)O— or alkylene or alkylidene groups of 1 to 6 carbon atoms, wherein at least one of the linking groups is —S—; and
   n, m, i, j, k, l, o, and p are independently 0, 1, 2, 3, or 4, subject to the proviso that their sum total is not less than 2.

The arylene units Ar¹, Ar², Ar³, and Ar⁴ may be selectively substituted or unsubstituted. Advantageous arylene units are phenylene, biphenylene, naphthalene, anthracene and phenanthrene. The polyarylene sulfide typically includes more than about 30 mol %, more than about 50 mol %, or more than about 70 mol % arylene sulfide (—S—) units. For example, the polyarylene sulfide may include at least 85 mol % sulfide linkages attached directly to two aromatic rings. In one particular embodiment, the polyarylene sulfide is a polyphenylene sulfide, defined herein as containing the phenylene sulfide structure —(C₆H₄—S)ₙ— (wherein n is an integer of 1 or more) as a component thereof.

Synthesis techniques that may be used in making a polyarylene sulfide are generally known in the art. By way of example, a process for producing a polyarylene sulfide can include reacting a material that provides a hydrosulfide ion (e.g., an alkali metal sulfide) with a dihaloaromatic compound in an organic amide solvent. The alkali metal sulfide can be, for example, lithium sulfide, sodium sulfide, potassium sulfide, rubidium sulfide, cesium sulfide or a mixture thereof. When the alkali metal sulfide is a hydrate or an aqueous mixture, the alkali metal sulfide can be processed according to a dehydrating operation in advance of the polymerization reaction. An alkali metal sulfide can also be generated in situ. In addition, a small amount of an alkali metal hydroxide can be included in the reaction to remove or react impurities (e.g., to change such impurities to harmless materials) such as an alkali metal polysulfide or an alkali metal thiosulfate, which may be present in a very small amount with the alkali metal sulfide.

The dihaloaromatic compound can be, without limitation, an o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide or dihalodiphenyl ketone. Dihaloaromatic compounds may be used either singly or in any combination thereof. Specific exemplary dihaloaromatic compounds can include, without limitation, p-dichlorobenzene; m-dichlorobenzene; o-dichlorobenzene; 2,5-dichlorotoluene; 1,4-dibromobenzene; 1,4-dichloronaphthalene; 1-methoxy-2,5-dichlorobenzene; 4,4′-dichlorobiphenyl; 3,5-dichlorobenzoic acid; 4,4′-dichlorodiphenyl ether; 4,4′-dichlorodiphenylsulfone; 4,4′-dichlorodiphenylsulfoxide; and 4,4′-dichlorodiphenyl ketone. The halogen atom can be fluorine, chlorine, bromine or iodine, and two halogen atoms in the same dihalo-aromatic compound may be the same or different from each other. In one embodiment, o-dichlorobenzene, m-dichlorobenzene, p-dichlorobenzene or a mixture of two or more compounds thereof is used as the dihalo-aromatic compound. As is known in the art, it is also possible to use a monohalo compound (not necessarily an aromatic compound) in combination with the dihaloaromatic compound in order to form end groups of the polyarylene sulfide or to regulate the polymerization reaction and/or the molecular weight of the polyarylene sulfide.

The polyarylene sulfide(s) may be homopolymers or copolymers. For instance, selective combination of dihaloaromatic compounds can result in a polyarylene sulfide copolymer containing not less than two different units. For instance, when p-dichlorobenzene is used in combination with m-dichlorobenzene or 4,4′-dichlorodiphenylsulfone, a polyarylene sulfide copolymer can be formed containing segments having the structure of formula:

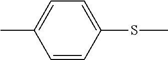

and segments having the structure of formula:

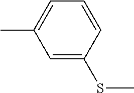

or segments having the structure of formula:

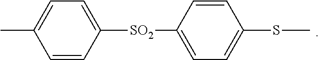

The polyarylene sulfide may be linear, semi-linear, branched or crosslinked. Linear polyarylene sulfides typically contain 80 mol % or more of the repeating unit —(Ar—S)—. Such linear polymers may also include a small amount of a branching unit or a cross-linking unit, but the amount of branching or cross-linking units is typically less than about 1 mol % of the total monomer units of the polyarylene sulfide. A linear polyarylene sulfide polymer may be a random copolymer or a block copolymer containing the above-mentioned repeating unit. Semi-linear polyarylene sulfides may likewise have a cross-linking structure or a branched structure introduced into the polymer a small amount of one or more monomers having three or more reactive functional groups. By way of example, monomer components used in forming a semi-linear polyarylene sulfide can include an amount of polyhaloaromatic compounds having two or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, etc., and mixtures thereof.

Another suitable semi-crystalline aromatic polymer that may be employed in the present invention is a polyaryletherketone. Polyaryletherketones are semi-crystalline polymers with a relatively high melting temperature, such as from about 300° C. to about 400° C., in some embodiments from about 310° C. to about 390° C., and in some embodiments from about 330° C. to about 380° C. The glass transition temperature may likewise be from about 110° C. to about 200° C. Particularly suitable polyaryletherketones are those that primarily include phenyl moieties in conjunction with ketone and/or ether moieties. Examples of such polymers include polyetheretherketone (“PEEK”), polyetherketone (“PEK”), polyetherketoneketone (“PEKK”), polyetherketoneetherketoneketone (“PEKEKK”), polyetheretherketoneketone (“PEEKK”), polyether-diphenyl-ether-ether-diphenyl-ether-phenyl-ketone-phenyl, etc., as well as blends and copolymers thereof.

In addition to the polymers referenced above, crystalline polymers may also be employed in the polymer composition. Particularly suitable are liquid crystalline polymers, which have a high degree of crystallinity that enables them to effectively fill the small spaces of a mold. Liquid crystalline polymers are generally classified as “thermotropic” to the extent that they can possess a rod-like structure and exhibit a crystalline behavior in their molten state (e.g., thermotropic nematic state). These polymers may also be generally referred to as polyesters. The polymers have a relatively high melting temperature, such as from about 250° C. to about 400° C., in some embodiments from about 280° C. to about 390° C., and in some embodiments from about 300° C. to about 380° C. Such polymers may be formed from one or more types of repeating units as is known in the art. A liquid crystalline polymer may, for example, contain one or more aromatic ester repeating units, typically in an amount of from about 60 mol. % to about 99.9 mol. %, in some embodiments from about 70 mol. % to about 99.5 mol. %, and in some embodiments from about 80 mol. % to about 99 mol. % of the polymer. The aromatic ester repeating units may be generally represented by the following Formula (I):

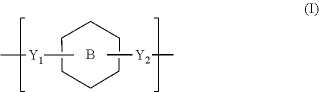

wherein,
   ring B is a substituted or unsubstituted 6-membered aryl group (e.g., 1,4-phenylene or 1,3-phenylene), a substituted or unsubstituted 6-membered aryl group fused to a substituted or unsubstituted 5- or 6-membered aryl group (e.g., 2,6-naphthalene), or a substituted or unsubstituted 6-membered aryl group linked to a substituted or unsubstituted 5- or 6-membered aryl group (e.g., 4,4-biphenylene); and
   Y₁ and Y₂ are independently O, C(O), NH, C(O)HN, or NHC(O).

Typically, at least one of Y₁ and Y₂ are C(O). Examples of such aromatic ester repeating units may include, for instance, aromatic dicarboxylic repeating units (Y₁ and Y₂ in Formula I are C(O)), aromatic hydroxycarboxylic repeating units (Y₁ is O and Y₂ is C(O) in Formula I), as well as various combinations thereof.

Aromatic dicarboxylic repeating units, for instance, may be employed that are derived from aromatic dicarboxylic acids, such as terephthalic acid, isophthalic acid, 2,6-naphthalenedicarboxylic acid, diphenyl ether-4,4′-dicarboxylic acid, 1,6-naphthalenedicarboxylic acid, 2,7-naphthalenedicarboxylic acid, 4,4′-dicarboxybiphenyl, bis(4-carboxyphenyl)ether, bis(4-carboxyphenyl)butane, bis(4-carboxyphenyl)ethane, bis(3-carboxyphenyl)ether, bis(3-carboxyphenyl)ethane, etc., as well as alkyl, alkoxy, aryl and halogen substituents thereof, and combinations thereof. Particularly suitable aromatic dicarboxylic acids may include, for instance, terephthalic acid (“TA”), isophthalic acid (“IA”), and 2,6-naphthalenedicarboxylic acid (“NDA”). When employed, repeating units derived from aromatic dicarboxylic acids (e.g., IA, TA, and/or NDA) each typically constitute from about 1 mol. % to about 40 mol. %, in some embodiments from about 2 mol. % to about 30 mol. %, and in some embodiments, from about 5 mol. % to about 25% of the polymer.

Aromatic hydroxycarboxylic repeating units may also be employed that are derived from aromatic hydroxycarboxylic acids, such as, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof, and combination thereof. Particularly suitable aromatic hydroxycarboxylic acids are 4-hydroxybenzoic acid (“HBA”) and 6-hydroxy-2-naphthoic acid (“HNA”). When employed, repeating units derived from hydroxycarboxylic acids (e.g., HBA and/or HNA) typically constitute about 20 mol. % or more, in some embodiments about 25 mol. % or more, in some embodiments about 30 mol. % or more, in some embodiments about 40 mol. % or more, in some embodiments about 50 mole % or more, in some embodiments from about 55 mol. % to 100 mol. %, and in some embodiments, from about 60 mol. % to about 95 mol. % of the polymer.

Other repeating units may also be employed in the polymer. In certain embodiments, for instance, repeating units may be employed that are derived from aromatic diols, such as hydroquinone, resorcinol, 2,6-dihydroxynaphthalene, 2,7-dihydroxynaphthalene, 1,6-dihydroxynaphthalene, 4,4′-dihydroxybiphenyl (or 4,4′-biphenol), 3,3′-dihydroxybiphenyl, 3,4′-dihydroxybiphenyl, 4,4′-dihydroxybiphenyl ether, bis(4-hydroxyphenyl)ethane, etc., as well as alkyl, alkoxy, aryl and halogen substituents thereof, and combinations thereof. Particularly suitable aromatic diols may include, for instance, hydroquinone (“HQ”) and 4,4′-biphenol (“BP”). When employed, repeating units derived from aromatic diols (e.g., HQ and/or BP) typically constitute from about 1 mol. % to about 50 mol. %, in some embodiments from about 1 to about 40 mol. %, in some embodiments from about 2 mol. % to about 40 mol. %, in some embodiments from about 5 mol. % to about 35 mol. %, and in some embodiments, from about 5 mol. % to about 25% of the polymer. Repeating units may also be employed, such as those derived from aromatic amides (e.g., acetaminophen (“APAP”)) and/or aromatic amines (e.g., 4-aminophenol (“AP”), 3-aminophenol, 1,4-phenylenediamine, 1,3-phenylenediamine, etc.). When employed, repeating units derived from aromatic amides (e.g., APAP) and/or aromatic amines (e.g., AP) typically constitute from about 0.1 mol. % to about 20 mol. %, in some embodiments from about 0.5 mol. % to about 15 mol. %, and in some embodiments from about 1 mol. % to about 10 mol. % of the polymer. It should also be understood that various other monomeric repeating units may be incorporated into the polymer. For instance, in certain embodiments, the polymer may contain one or more repeating units derived from non-aromatic monomers, such as aliphatic or cycloaliphatic hydroxycarboxylic acids, dicarboxylic acids, diols, amides, amines, etc. Of course, in other embodiments, the polymer may be “wholly aromatic” in that it lacks repeating units derived from non-aromatic (e.g., aliphatic or cycloaliphatic) monomers.

In some preferred embodiments, the polymer composition contains an aliphatic polyamide, such as polyamide 6 and/or polyamide 6,6. Polyamides based on a blend of polyamide 6,6 and polyamide 6 may be particularly useful if the presence of polyamide 6 is less than 40 wt. % based on the total weight of the polyamide 6,6 and polyamide 6. Among these polyamide resins, those having a number-average molecular weight of about 7,000 to 30,000 are preferably used.

The polymers within the polymer matrix may be present in an amount of about 30 wt. % or more, in some embodiments about 40 wt. % or more, in some embodiments from about 40 wt. % to about 99.5 wt. %, in some embodiments from about 50 wt. % to about 95 wt. %, in some embodiments, from about 60 wt. % to about 90 wt. %, and in some embodiments, from about 60 wt. % to about 85 wt. % of the polymer composition.

In some embodiments, a fibrous reinforcing agent is included in the polymer composition in order to improve the mechanical strength such as tensile strength and flexural strength, and to suppress the shrinkage of the muffler.

Examples of the fibrous reinforcing agent include: inorganic fiber such as glass fiber, carbon fiber, graphite fiber, silica-alumina fiber, zirconia fiber, ceramic fiber, metal fiber such as fiber of stainless steel, aluminum, titanium, copper, or brass; and organic fiber such as para-aramid fiber, meta-aramid fiber, fluorine resin fiber, or liquid crystalline aromatic fiber. Such fibers can be used alone or in combination with each other. In terms of reinforcing effect, the fibrous reinforcing agent is preferably glass fiber, carbon fiber, or para-aramid fiber. Considering availability and cost, glass fiber is preferred.

Among glass fibers, preferred are chopped strands produced from E-glass (alkali-free glass). The average fiber diameter of the fibrous reinforcing agent is not specifically limited. For example, in some embodiments, it is within the range of 1 to 100 μm, in some embodiments about 3 to 30 μm, and in some embodiments, about 5 to 15 μm. The mean fiber length of the fibrous reinforcing agent is also not specifically limited, and for example, may be within the range of about 2 to 4 mm before compounding.

In addition, the fibrous reinforcing agent may be surface-treated, as necessary, through the use of a surface-treatment agent (e.g., epoxy-based compound, acrylic-based compound, isocyanate-based compound, silane-based compound, or titanate-based compound). The glass fiber is preferably surface-treated with a silane-based compound (also known as silane coupling agent), particularly when used in a polyamide resin matrix.

When employed, the amount of the fibrous reinforcing agent in the composition can range from about 5 to 45 wt. %, in some embodiments from about 20 to 40 wt. %, and in some embodiments, from about 25 to 35 wt. %, based on the total weight of the polymer composition.

When a fibrous reinforcing agent is present, the weight ratio between the polymer resin and the fibrous reinforcing agent ranges from about 50:50 to 95:5; in some embodiments from about 55:45 to 85:15; in some embodiments from about 60:40 to 80:20; and in some embodiments, from about 65:35 to 75:25.

The polymer composition may further contain a particulate filler. Examples of the particulate filler may include, for example, boron-containing compounds (e.g., boron nitride, sodium tetraborate, potassium tetraborate, calcium tetraborate, etc.), alkaline earth metal carbonates (e.g., calcium magnesium carbonate), oxides (e.g., titanium oxide, aluminum oxide, magnesium oxide, zinc oxide, antimony trioxide, etc.), silicates (e.g., talc, sodium aluminum silicate, calcium silicate, magnesium silicate, etc.), salts of alkaline earth metals (e.g., calcium carbonate, calcium sulfate, etc.), and the like. For example, the present inventors discovered that the addition of ZnO to the polymer matrix in the presence of a fibrous reinforcing agent can provide compositions having improved vibration damping and noise reduction properties.

Without wishing to be bound by theory, it has been hypothesized that the damping effect of zinc oxide may be due to its piezoelectric property.

Preferably, when employed, the zinc oxide is a crystalline zinc oxide in needle, dendrite or wire shape. In some embodiments, the zinc oxide is nano-zinc oxide (N—ZnO) or zinc oxide whisker a e.g., tetrapod-shaped zinc oxide whisker (T-ZnOw). Nanoparticles are particles which, through suitable production processes, have mean particle sizes of 5 to 100 nm.

Zinc oxide whisker (e.g., T-ZnOw) has a tetrapod shape in a micro-image and a porous appearance in bulk. Under a microscope, the zinc oxide crystal has four needle crystals extending from the central body. Each needle (or whisker) has a length of greater than 3 micrometers measuring from its basal part contacting the central body to the tip. The whiskers of T-ZnOw are known to be flexible and have a high modules of elasticity and a very high specific density of about 5.8. T-ZnOw possesses advantageous properties compared to zinc oxide in other crystalline forms due to its peculiar shape such as high strength and high elasticity.

Zinc oxide may be surface-treated, as necessary, through the use of a surface-treatment agent as described above. Nano-zinc oxide is preferably surface-treated with a silane-based compound (also known as silane coupling agent) in order to provide a good dispersion of the nanoparticles within the polymeric matrix. Zinc oxide whiskers are less prone to particulate aggregation and are preferably not surface-treated with a silane coupling agent.

In one embodiment, the polymer composition contains nano-zinc oxide having a particle size ranging from about 10 to 60 nm.

In another embodiment, the composition contains zinc oxide whiskers in the micrometer range. In one embodiment, the zinc oxide is a tetrapod-shaped zinc oxide whisker and has not been surface treated with silane coupling agent.

In some embodiments, the particulate filler may include clay minerals. Examples of such clay minerals include, for example, talc (Mg)₃Si₄O₁₀(OH)₂) halloysite (Al)₂Si₂O(OH)₄) kaolinite (Al)₂Si₂O₅(OH)₄) illite ((K, H)₃O)(Al,Mg,Fe)₂(Si,Al)₄O₁₀[(OH)₂,(H₂O)]) montmorillonite (Na, Ca)_{0.33}(Al,Mg)₂Si₄O₁₀(OH)₂·nH₂O), vermiculite ((MgFe,Al)₃(Al,Si)₄O₁₀(OH)₂·4H₂O), palygorskite ((Mg,Al)₂Si₄O₁₀(OH)·4(H₂O)), pyrophyllite (Al))₂Si₄O₁₀(OH)₂) and the like, as well as combinations thereof. Other suitable silicate fillers may also be used, such as calcium silicate, aluminum silicate, mica, diatomaceous earth, wollastonite, and the like. For example, mica can be a particularly suitable mineral for use in the present invention. As used herein, the term “mica” is meant to generally include any of these materials, such as muscovite (KAl)₂(AlSi₃)O₁₀(OH)₂) biotite (K (Mg, Fe)₃(AlSi₃)O₁₀(OH)₂) phlogopite (KMg)₃(AlSi₃)O₁₀(OH)₂) lepidolite (K (Li, Al)₂₋₃ (AlSi₃)O₁₀(OH)₂) glauconite (K, Na) (Al, Mg, Fe)₂(Si,Al)₄O₁₀(OH)₂) and the like, as well as combinations thereof.

When employed, the amount of the particulate filler employed in the composition can range from about 1 to 25 wt. %, and in some embodiments, from about 5 to 10 wt. %, based on the total weight of the polymer composition.

A wide variety of additional additives can also be included in the polyamide composition, such as impact modifiers, compatibilizers, particulate fillers (e.g., mineral fillers), lubricants, pigments, antioxidants, light stabilizers, heat stabilizers, and/or other materials added to enhance properties and processability. In some embodiments, the composition is free of flame retardants.

The polymer matrix and other optional additives may be melt processed or blended together. The components may be supplied separately or in combination to an extruder that includes at least one screw rotatably mounted and received within a barrel (e.g., cylindrical barrel) and may define a feed section and a melting section located downstream from the feed section along the length of the screw. The extruder may be a single screw or twin-screw extruder. The speed of the screw may be selected to achieve the desired residence time, shear rate, melt processing temperature, etc. For example, the screw speed may range from about 50 to about 800 revolutions per minute (“rpm”), in some embodiments from about 70 to about 150 rpm, and in some embodiments, from about 80 to about 120 rpm. The apparent shear rate during melt blending may also range from about 100 seconds 1 to about 10,000 seconds 1, in some embodiments from about 500 seconds 1 to about 5000 seconds 1, and in some embodiments, from about 800 seconds 1 to about 1200 seconds 1. The apparent shear rate is equal to 4Q/R3, where Q is the volumetric flow rate (“m3/s”) of the polymer melt and R is the radius (“m”) of the capillary (e.g., extruder die) through which the melted polymer flows.

Regardless of the manner in which the components are incorporated into the composition, the resulting melt viscosity is generally low enough that it can readily flow into the cavity of a mold to form a small-sized circuit substrate. For example, in one particular embodiment, the polymer composition may have a melt viscosity of from about 5 Pa-s or more, in some embodiments about 30 Pa-s or more, in some embodiments from about 80 Pa-s to about 1000 Pa-s, in some embodiments from about 100 Pa-s to about 700 Pa-s, in some embodiments from about 200 Pa-s to about 600 Pa-s, and in some embodiments from about 250 Pa-s to about 500 Pa-s, as determined at a shear rate of 1,000 seconds⁻¹.

The present inventors discovered that the noise reduction capability of the muffler is improved when the muffler is formed from certain polymer compositions. For example, noise reduction is improved when the muffler is formed from a polymer composition having a high tan delta, such as about 0.1 or greater, in some embodiments about 0.12 or greater, in some embodiments about 0.15 or greater, in some embodiments about 0.18 or greater, and in some embodiments, about 0.2 or greater, as measured using dynamic mechanical analysis at 60° C.

The polymer composition may also possess excellent thermal and mechanical properties and processability. For example, the melting temperature of the polymer composition may, for instance, be about 200° C. to about 400° C., in some embodiments from about 220° C. to about 380° C., in some embodiments from about 250° C. to about 360° C., and in some embodiments from about 260° C. to about 350° C. The deflection temperature under load (“DTUL”), a measure of short-term heat resistance, may be about 50° C. or more, in some embodiments from about 60° C. to about 350° C., in some embodiments from about 70° C. to about 320° C., and in some embodiments, from about 75° C. to about 290° C.

The polymer composition may also possess excellent mechanical properties. For example, the polymer composition may exhibit a tensile strength of about 10 MPa or more, in some embodiments about 50 MPa or more, in some embodiments from about 100 MPa to about 300 MPa, in some embodiments from about 150 MPa to about 275 MPa, and in some embodiments from about 200 MPa to about 250 MPa. The polymer composition may exhibit a tensile elongation at break of about 1% or more, in some embodiments about 2% or more, in some embodiments from about 3% to about 30%, and in some embodiments from about 5% to about 25%. The polymer composition may exhibit a tensile modulus of about 1,000 MPa or more, in some embodiments about 5,000 MPa or more, in some embodiments about 7,000 MPa to about 25,000 MPa, and in some embodiments from about 11,000 MPa to about 20,000 MPa. The tensile properties may be determined at a temperature of 23° C. in accordance with ISO Test No. 527:2019. Also, the polymer composition may exhibit a flexural strength of about 20 MPa or more, in some embodiments about 100 MPa or more, in some embodiments about 150 MPa or more, in some embodiments from about 190 MPa to about 500 MPa, and in some embodiments from about 220 MPa to about 300 MPa. The polymer composition may exhibit a flexural modulus of about 1,000 MPa or more, in some embodiments about 5,000 MPa or more, in some embodiments about 8,000 MPa to about 25,000 MPa, and in some embodiments from about 10,000 MPa to about 20,000 MPa. The flexural properties may be determined at a temperature of 23° C. in accordance with 178:2010. Furthermore, the polymer composition may also possess a high impact strength, which may be useful when forming thin substrates. The polymer composition may, for instance, possess a Charpy notched impact strength of about 2 kJ/m² or more, in some embodiments about 10 kJ/m² or more, in some embodiments from about 15 to about 30 KJ/m², and in some embodiments from about 18 kJ/m² to about 25 kJ/m². The impact strength may be determined at a temperature of 23° C. in accordance with ISO Test No. ISO 179-1:2010.

The muffler may be formed from the polymer composition using a variety of different techniques. Suitable techniques may include, for instance, injection molding, low-pressure injection molding, extrusion compression molding, gas injection molding, foam injection molding, low-pressure gas injection molding, low-pressure foam injection molding, gas extrusion compression molding, foam extrusion compression molding, extrusion molding, foam extrusion molding, compression molding, foam compression molding, gas compression molding, etc. For example, an injection molding system may be employed that includes a mold within which the polymer composition may be injected. The time inside the injector may be controlled and optimized so that polymer matrix is not pre-solidified. When the cycle time is reached and the barrel is full for discharge, a piston may be used to inject the composition to the mold cavity. Compression molding systems may also be employed. As with injection molding, the shaping of the polymer composition into the desired article also occurs within a mold. The composition may be placed into the compression mold using any known technique, such as by being picked up by an automated robot arm. The temperature of the mold may be maintained at or above the solidification temperature of the polymer matrix for a desired time period to allow for solidification. The molded product may then be solidified by bringing it to a temperature below that of the melting temperature. The resulting product may be de-molded. The cycle time for each molding process may be adjusted to suit the polymer matrix, to achieve sufficient bonding, and to enhance overall process productivity.

In other embodiments, the muffler may be formed by an additive manufacturing process (e.g., 3D printing). Various types of three-dimensional printing techniques may be employed, such as extrusion-based systems (e.g., fused deposition modeling), powder bed fusion, electrophotography, etc. When employed in a fused deposition modeling system, for instance, the polymer composition may be employed as the build material that forms the three-dimensional structure and/or the support material that is removed from the three-dimensional structure after it is formed. Advantageously, 3D printing may be used to produce prototype mufflers which can be tested for their noise reducing properties. For example, a proposed muffler design can be 3D printed into a prototype and can be placed in the computer system and tested to see whether it meets the target value(s) for noise reduction in the relevant frequency band(s). 3D printing is useful for preparing such rapid prototypes for testing because it generally does not require any tooling or mold cavities to be produced.

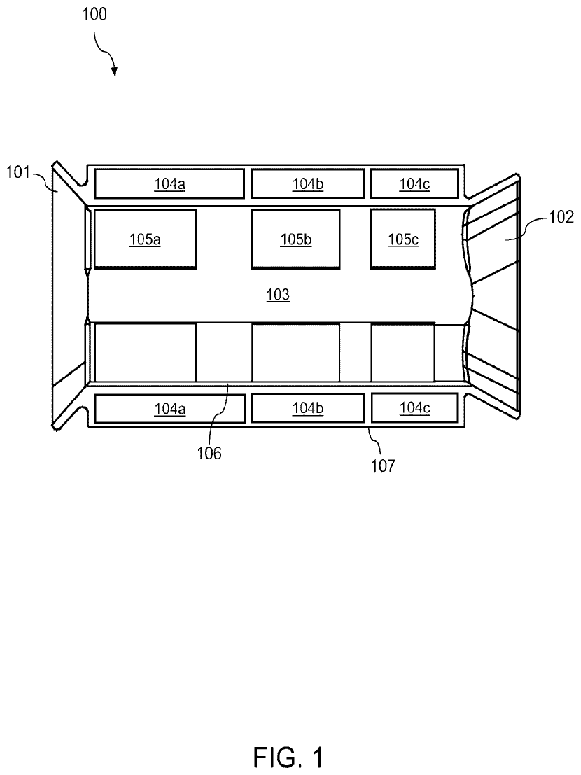

The muffler generally comprises an inlet, an outlet, a main duct, at least one resonance cavity, and a plurality of apertures allowing for airflow between the main duct and the at least one resonance cavity. One embodiment of such a muffler is illustrated by FIG. 1. As shown, the muffler 100 comprises a conical inlet 101, a conical outlet 102, and a main duct 103 extending from the inlet 101 to the outlet 102. The main duct 103 is surrounded by three resonance cavities, 104a, 104b, and 104c. Apertures 105a, 105b, and 105c allow air to flow between the main duct 103 and the resonance cavities 104a, 104b, and 104c, respectively. In the embodiment shown in FIG. 1, the resonance cavities get progressively smaller from the inlet 101 to the outlet 102. For example, resonance cavity 104a is larger than 104b, which is larger than 104c. However, it should be understood that there is no limit on the relative size of the cavities. For example, they may all be the same size, or they may get progressively larger from the inlet to the outlet. Similarly, there is no limit to the number of resonance cavities. For example, in some embodiments, there may only be a single resonance cavity, while in others there may be more than three.

The resonance cavities are formed between an inner wall 106 and an outer wall 107. The inner surface of the inner wall 106 defines the main duct 103. The outer surface of the outer wall 107 defines the outer diameter of the muffler 100. The relative size of the resonance cavity in the radial direction can vary as desired in order to meet the requirements for noise reduction. For example, the ratio (a/b) of (a) the radial length from the inner wall 106 to the outer wall 107 to (b) a diameter of the main duct may be from about 0.05 to about 1, in some embodiments from about 0.5 to about 0.8, in some embodiments from about 0.1 to about 0.3, and in some embodiments from about 0.15 to about 0.25.

Additionally, as shown in FIG. 1, it can be seen that the resonance chambers 104a, 104b, and 104c extend further in the axial direction than respective apertures 105a, 105b, and 105c. However, it should be understood that the apertures may extend the whole length of the resonance chambers, or there may be multiple apertures in the axial direction corresponding to each resonance chamber. For example, the ratio of the axial length of each aperture to the axial length of the resonance chamber corresponding to it can be from about 0.1 to about 1, in some embodiments from about 0.5 to about 1, in some embodiments from about 0.6 to about 0.9, and in some embodiments, from about 0.7 to about 0.8. In some embodiments, apertures can constitute from about 5% to about 80% of the area on the inner wall of the one or more resonance cavities, in some embodiments from about 15% to about 75%, in some embodiments from about 25% to about 65%, in some embodiments from about 30% to about 60%, and in some embodiments, from about 40% to about 60%. In some embodiments, the thickness of the inner wall can be from about 0.5 mm to about 5 mm, and in some embodiments from about 1 mm to about 3 mm.

When the heat dissipation fan is configured to blow air away from the heat generating computing components, the outlet of the muffler can be sized to fit around the inlet of the heat dissipation fan and up to the size of the heat dissipation fan frame. The diameter of the main duct can be about the same as the diameter of the heat dissipation fan inlet or smaller. When the heat dissipation fan is configured to blow air toward the heat generating computing components, the inlet of the muffler can be sized to fit around the outlet of the heat dissipation fan and up to the size of the heat dissipation fan frame.

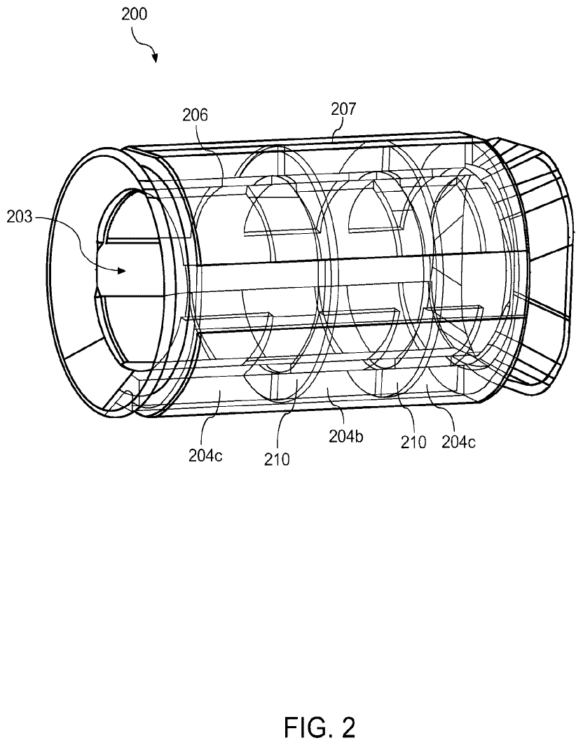

The internal structure of the muffler can be seen more clearly in FIG. 2. As shown, the muffler 200 comprises two interior ring walls 210 which extend radially between the inner wall 206 and the outer wall 207 and separate the respective resonance chambers 204a, 204b, and 204c from each other. It can also be seen that each resonance chamber is accessible from the main duct 203 by four apertures.

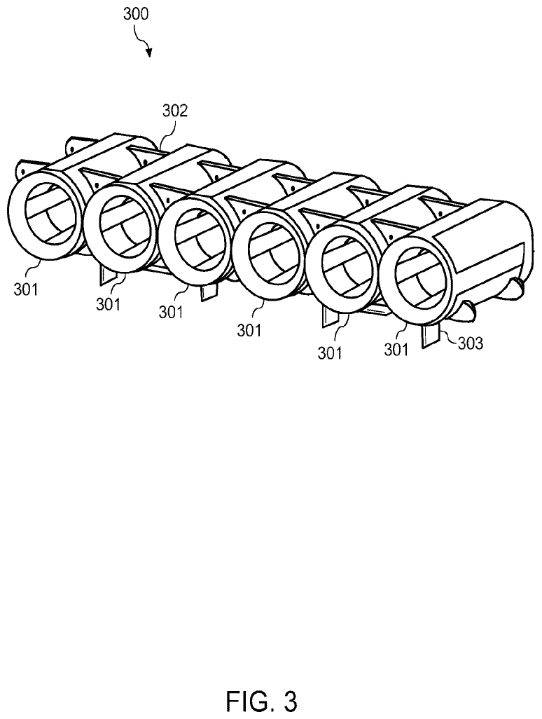

As shown in FIG. 3, in one embodiment multiple mufflers can be produced as an integral set. Such a set can be inserted into a computer system having the same number of heat dissipation fans in a row. For example, in FIG. 3 a set of mufflers 300 contains six different mufflers 301 integrally attached to each other by connectors 302. Additionally, the set of mufflers 300 is attached to a frame 303, which can be formed to support the mufflers within the chassis of the computer system.

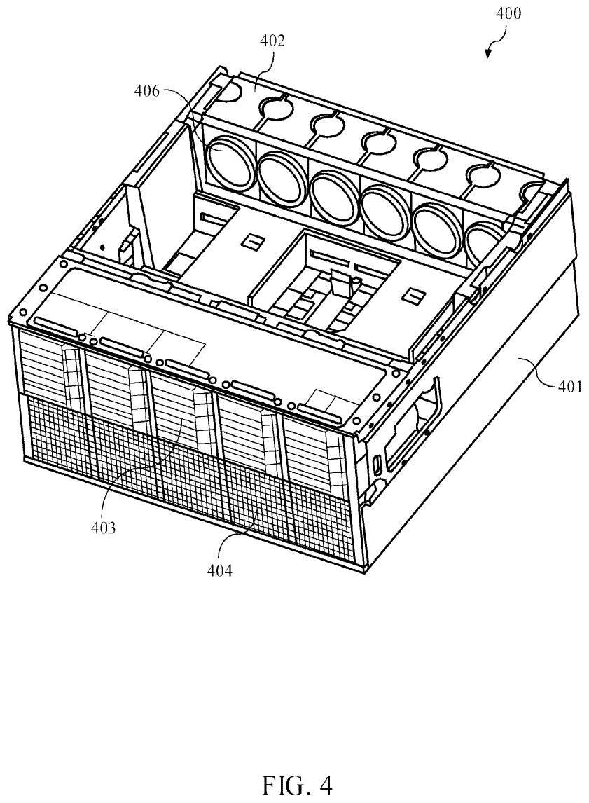

FIG. 4 shows a computer system to which a set of mufflers can be added. The system 400 comprises a chassis 401, heat dissipation fans 402, and computing components 403. In the system shown in FIG. 4, the heat dissipation fans 402 are configured to blow air away from the computing components 403, thereby exhausting the warmed air and drawing cooler air from environment into the chassis through a vent 404. As such, the heat dissipation inlets 406 face the interior of the chassis 401 and the computing components 403. Computer systems (e.g., rack servers) such as that shown in FIG. 4 can be conveniently stacked together to form larger systems, which may be a part of a larger cloud computing data center.

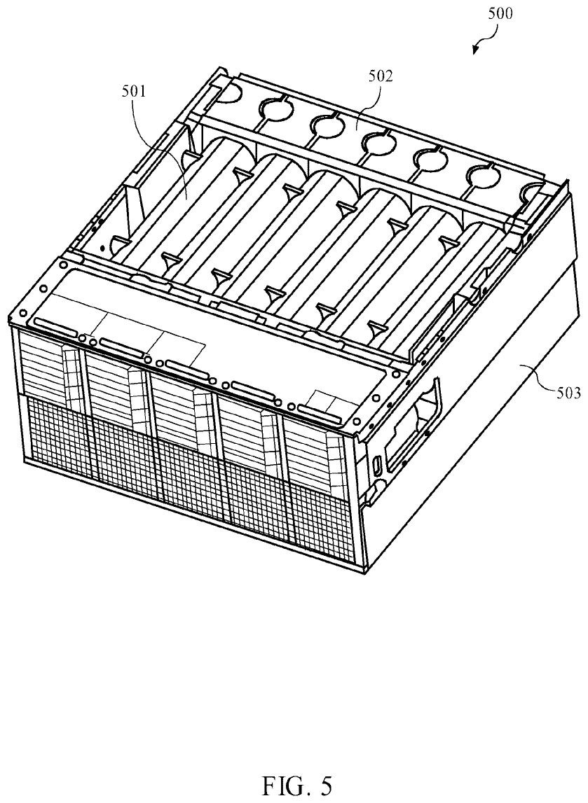

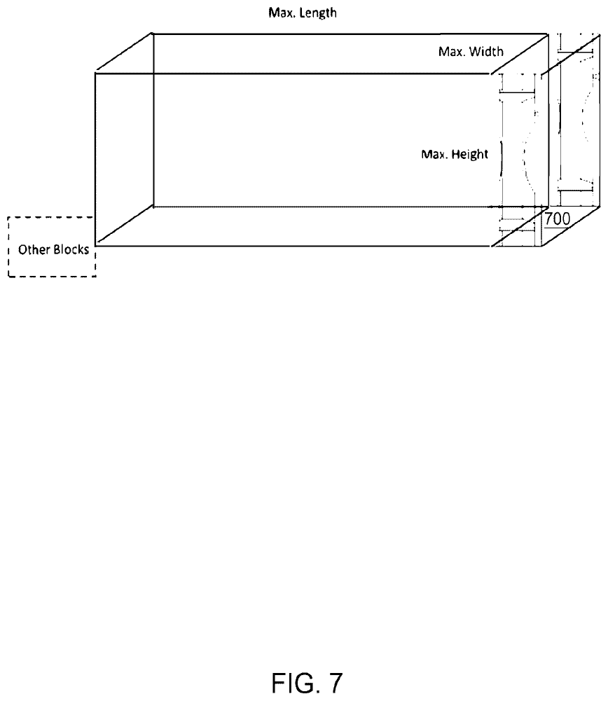

FIG. 5 shows a computer system 500, such as that shown in FIG. 4 with a set of mufflers 501 attached to the set of heat dissipation fans 502. The frame of the set of mufflers 501 supports the mufflers and rests on fan frame 700 (shown in FIG. 7) within the chassis 503. In the computer system shown in FIG. 5, the set of mufflers 501 corresponds to the heat dissipation fans 502 on the upper level of the chassis. In some embodiments, there may multiple levels of heat dissipation fans within the chassis. Mufflers may be attached to all rows or only some rows. For example, with reference to FIG. 4, there is room for mufflers on the upper level of the chassis but not the lower level.

The mufflers may be attached to the fans by any suitable method. For example, they may be attached to the fans using an adhesive and rivets. Preferably, there is no air gap between the inlet or outlet of each muffler and the inlet or outlet of each fan, so that all of the air drawn by the fan passes through the muffler.

While the computer system shown in FIGS. 4 and 5 is a server, it should be understood that the computer system may be any computer system cooled by a heat dissipation fan. For example, the computer system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, the computer system may be a personal computer, a PDA, a consumer electronic device, a network storage device, or any other suitable device and may vary in size, shape, performance, functionality, and price. The heat generating computing components within the computer system may include random access memory (RAM), one or more processing resources such as a central processing unit (CPU) or hardware or software control logic, ROM, and/or other types of nonvolatile memory. Additional components of the computer system may include one or more disk drives, one or more network ports for communicating with external devices as well as various input and output (I/O) devices, such as a keyboard, a mouse, and a video display. The computer system may also include one or more buses operable to transmit communications between the various hardware components.

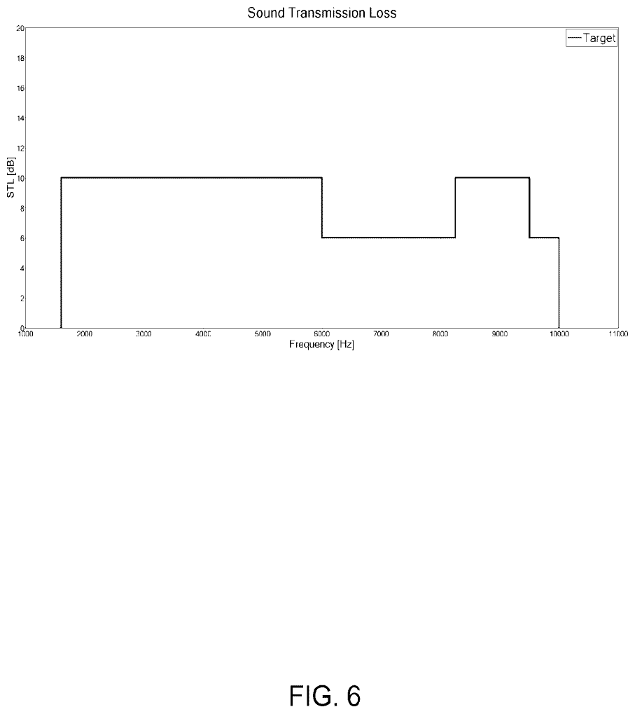

In the method for reducing noise from a heat dissipation fan in a computer system, the system can first be analyzed to determine the requirements for noise reduction. In the analysis, the computer system can be run under the maximum speed of the heat dissipation fan(s) and the sound pressure level can be measured at the location of a hard disk drive (HDD). Meanwhile, the input/output status of the HDD can be measured to establish a baseline value for the original state. The fan speed and thus the sound pressure level can then be manipulated until a critical sound pressure level is found. The critical sound pressure level is the maximum level at which the HDD performs adequately. The maximum sound pressure level can then be compared to the critical sound pressure level. From this comparison, the frequencies at which the maximum sound pressure level exceeds the critical level can be determined. The difference between the maximum sound pressure level and the critical value can be the target value for sound transmission loss within a frequency band covering the frequency at the peak sound pressure level. An exemplary target sound transmission loss profile which can be created from the analysis is shown in FIG. 6.

Additionally, the maximum volume of the muffler can be determined. In one embodiment, the maximum cross-sectional area of the muffler is the cross sectional-area of the heat dissipation fan frame. The maximum length of the muffler can be determined by extending that maximum cross section along the normal direction of the inlet/outlet of the heat dissipation fan until interference occurs with other devices or structures. The maximum volume is the product of the maximum cross-sectional area and the maximum length. FIG. 7 is a diagram illustrating this concept. It can be seen that the maximum width and height correspond to the height and width of the fan frame 700 and that the maximum length is determined by extending a cross section defined by the maximum height and width until it reaches another structural component.

Once the target value(s) for sound transmission loss and the maximum volume for the muffler are found, a muffler structure can be designed. In some embodiments, the main duct size is determined using the cross-sectional area of the inlet or outlet of the heat dissipation fan. Also, in some cases the diameter of the main duct may need to be smaller than the diameter of the inlet/outlet of the heat dissipation fan to obtain enough volume in the resonance chamber(s) surrounding the main duct.

Additionally, to promote the smooth flow air in the muffler and to reduce air flow resistance, a conical surface or a curved surface can be used to transition between the smaller inner diameter of the main duct and the diameter of the inlet of the fan.

When designing the muffler, the number of resonant cavities can be determined according to the width of the target frequency range, so that the sound transmission loss curve formed by connecting each peak can cover the magnitude of the target sound pressure value in the target frequency range as widely as possible. If a specific sound pressure peak needs to be eliminated, the sound pressure peak of a certain cavity can be correspondingly matched with the specific sound pressure peak in order to obtain the best sound reduction effect.

The sound pressure peak and corresponding frequency of each cavity are determined by the volume of the cavity, the area of the opening between the cavity and the main duct, and the thickness of the partition panel between the cavity and the main duct. The shape and total volume of all cavities should be limited within the maximum layout space of the muffler. In the design process of the muffler, simulation software can be used to predict whether the sound transmission loss of the design meets the sound reduction target requirements. If the sound transmission loss does not meet the target requirements, a modified design option can be formed by modifying the volume of the corresponding cavity and the opening size between the cavity and the main duct. These iterative design and simulation prediction steps can be repeated until the sound transmission loss curve meets the target requirements or a design option that basically meets the sound reduction requirements is obtained within the maximum layout space.

The muffler design can optionally be verified experimentally. For example, in one embodiment, 3D printing or other rapid prototyping methods are used to make the prototype according to a CAD model of the proposed design. After obtaining the prototype of the muffler, it can be installed in the computer system by, for example, using hot melt glue and rivets to ensure that the muffler and the heat dissipation fan are well connected without gaps. Then, the computer system can be started, and the noise level and hard disk input/output accuracy rate can be tested at maximum fan speed. If successful, the prototype muffler can be used in the system, or the successful design can be recreated using a different molding technique (e.g., injection molding).

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only and is not intended to limit the invention so further described in such appended claims.

### Test Methods

Melt Viscosity: The melt viscosity (Pa-s) may be determined in accordance with ISO Test No. 11443:20021 at a shear rate of 1,000 s⁻¹ and temperature 15° C. above the melting temperature (e.g., about 350° C.) using a Dynisco LCR7001 capillary rheometer. The rheometer orifice (die) had a diameter of 1 mm, length of 20 mm, L/D ratio of 20.1, and an entrance angle of 180°. The diameter of the barrel was 9.55 mm+0.005 mm and the length of the rod was 233.4 mm.

Melting Temperature: The melting temperature (“Tm”) may be determined by differential scanning calorimetry (“DSC”) as is known in the art. The melting temperature is the differential scanning calorimetry (DSC) peak melt temperature as determined by ISO Test No. 11357-2:2020. Under the DSC procedure, samples were heated and cooled at 20° C. per minute as stated in ISO Standard 10350 using DSC measurements conducted on a TA Q2000 Instrument.

Deflection Temperature Under Load (“DTUL”): The deflection under load temperature may be determined in accordance with ISO Test No. 75-2:2013 (technically equivalent to ASTM D648-18). More particularly, a test strip sample having a length of 80 mm, thickness of 10 mm, and width of 4 mm may be subjected to an edgewise three-point bending test in which the specified load (maximum outer fibers stress) was 1.8 Megapascals. The specimen may be lowered into a silicone oil bath where the temperature is raised at 2° C. per minute until it deflects 0.25 mm (0.32 mm for ISO Test No. 75-2:2013).

Tensile Modulus, Tensile Stress, and Tensile Elongation: Tensile properties may be tested according to ISO Test No. 527:2019 (technically equivalent to ASTM D638-14). Modulus and strength measurements may be made on the same test strip sample having a length of 80 mm, thickness of 10 mm, and width of 4 mm. The testing temperature may be 23° C., and the testing speeds may be 1 or 5 mm/min.

Flexural Modulus, Flexural Stress, and Flexural Elongation: Flexural properties may be tested according to ISO Test No. 178:2019 (technically equivalent to ASTM D790-17). This test may be performed on a 64 mm support span. Tests may be run on the center portions of uncut ISO 3167 multi-purpose bars. The testing temperature may be 23° C. and the testing speed may be 2 mm/min.

Unnotched and Notched Charpy Impact Strength: Charpy properties may be tested according to ISO Test No. ISO 179-1:2010) (technically equivalent to ASTM D6110-10, Method B). This test may be run using a Type 1 specimen size (length of 80 mm, width of 10 mm, and thickness of 4 mm). When testing the notched impact strength, the notch may be a Type A notch (0.25 mm base radius). Specimens may be cut from the center of a multi-purpose bar using a single tooth milling machine. The testing temperature may be 23° C.

Tan Delta: Dynamic mechanical analysis (DMA) is used herein for determination of storage modulus (E′) and loss modulus (E″), and glass transition, as a function of temperature. Tan delta is a curve resulting from the loss modulus divided by the storage modulus (E″/E′) as a function of temperature.

Dynamic mechanical analysis is discussed in detail in “Dynamic Mechanical Analysis: A practical Introduction,” Menard K. P., CRC Press (2008) ISBN is 978-1-4200-5312-8. Storage modulus (E′), loss modulus (E″) curves exhibit specific changes in response to molecular transitions occurring in the polymeric material in response to increasing temperature. A key transition is called glass transition. It characterizes a temperature range over which the amorphous phase of the polymer transitions from glassy to rubbery state and exhibits large scale molecular motion. Glass transition temperature is thus a specific attribute of a polymeric material and its morphological structure. The tan delta curve exhibits a prominent peak in this temperature range. This peak tan delta temperature is defined in the art as the tan delta glass transition temperature, and the height of the peak is a measure of the crystallinity of the polymeric material. A polymeric sample with low or no crystallinity exhibits a tall tan delta peak due to large contribution of the amorphous phase molecular motion, while a sample with high level of crystallinity exhibits a smaller peak because molecules in crystalline phase are not able to exhibit such large scale rubbery motion. Thus, herein the value of tan delta glass transition peak is used as a comparative indicator of level of crystallinity in the melt-blended thermoplastic polymer composition.

### Example

Sample 1 was formed from a polymer composition containing 65 wt. % polyamide 6,6 and 35 wt. % glass fibers having a tan delta of about 6%.

Sample 2 was formed from a polymer composition containing 65 wt. % polyamide 6,6 and 35 wt. % glass fibers having a tan delta of about 10%.

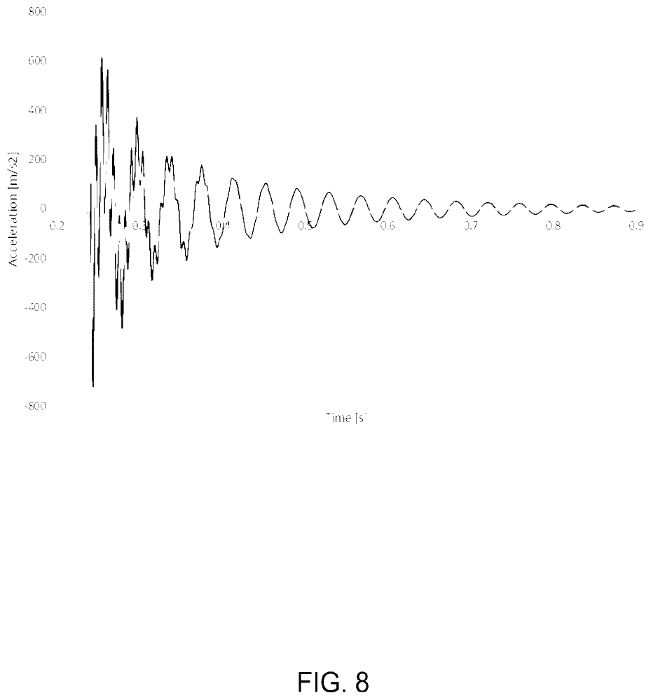

To test the damping properties of the two compositions, the samples were molded into rectangular cantilever beam test specimens and subjected to a free vibration test in which the free end of the beam was deflected and then released. The accelerations over time were measured by an accelerometer attached to the sample. The resulting acceleration curves are shown in FIG. 8. The darker curve is from Sample 1 and the lighter curve is from Sample 2. As can be seen, Sample 2 exhibited lower magnitude accelerations than Sample 1 and stabilized completely well before Sample 1.

What is claimed is:

1. A computer system comprising:
a chassis containing at least one heat-generating computing component;
at least one heat dissipating fan contained within the chassis configured to convectively cool the at least one heat-generating computing component; and
at least one muffler positioned at an inlet or outlet of the at least one heat dissipating fan, the at least one muffler comprising an inlet, an outlet, a main duct extending between the inlet and the outlet, at least one resonance chamber peripherally surrounding the main duct, and a plurality of apertures in the main duct configured to allow air and sound to flow and transfer between the main duct and the at least one resonance chamber.

2. The computer system of claim 1, wherein the muffler comprises a polymer composition containing a thermoplastic polymer.

3. The computer system of claim 2, wherein the thermoplastic polymer comprises an aliphatic polymer.

4. The computer system of claim 3, wherein the aliphatic polymer comprises an aliphatic polyamide.

5. The computer system of claim 4, wherein the aliphatic polyamide comprises polyamide 6 and/or polyamide 6,6.

6. The computer system of claim 2, wherein the polymer composition comprises at least one filler.

7. The computer system of claim 6, wherein the at least one filler comprises glass fibers.

8. The computer system of claim 6, wherein the at least one filler constitutes from about 1 wt. % to about 50 wt. % of the polymer composition.

9. The computer system of claim 2, wherein the polymer composition exhibits a tan delta of about 0.1 or greater at 60° C., as measured using dynamic mechanical analysis.

10. The computer system of claim 1, wherein the at least one muffler comprises at least two resonance chambers spaced axially from each other.

11. The computer system of claim 1, wherein the ratio (a/b) of (a) a radial length from an inner wall of the at least one resonance chamber to an outer wall of the at least one resonance chamber to (b) a diameter of the main duct is from about 0.05 to about 1.

12. The computer system of claim 1, wherein a diameter of the main duct is equal to or less than a diameter of the inlet or outlet of the at least one heat dissipating fan.

13. The computer system of claim 1, wherein the inlet and/or outlet of the at least one muffler has a conical shape.

14. The computer system of claim 1, wherein the at least one resonance chamber is a Helmholtz resonator, a quarter-wave tube resonator, or a resonant cavity.

15. The computer system of claim 1, wherein the system comprises more than one muffler integrally connected to each other.

16. A process for reducing the noise of a heat dissipation fan within a computer system, the process comprising:
obtaining a target value for noise reduction within at least one frequency band,
determining a maximum cross-sectional area and a maximum length for a muffler,
designing the muffler based on the target value for noise reduction and the maximum cross-sectional area and maximum length, the muffler comprising an inlet, an outlet, a main duct extending between the inlet and the outlet, at least one resonance chamber peripherally surrounding the main duct, and a plurality of apertures in the main duct configured to allow air and sound to flow and transfer between the main duct and the at least one resonance chamber, and
positioning the muffler at an inlet or outlet of the heat dissipation fan.

17. The process of claim 16, wherein the target value is determined by measuring the input/output status of a hard disk contained in the computer system under various noise levels, determining a maximum noise level within a specific frequency band to ensure normal operation of the hard disk, and calculating the difference between a peak noise level within that frequency band when the heat dissipation fan is operating at maximum speed and the maximum noise level to ensure normal operation of the hard disk.

18. The process of claim 16, wherein the maximum outer diameter is equal to a cross-sectional area of the heat dissipation fan and the maximum length is determined by extending the maximum cross-sectional area along the normal direction of the inlet or outlet of the heat dissipation fan until interference with another structure within the computer system.

19. The process of claim 16, wherein positioning the muffler at an inlet or outlet of the heat dissipation fan comprises using an adhesive or welding to attach the muffler to the heat dissipation fan with no air gaps.

20. The process of claim 16, wherein designing the muffler comprises using a software simulation or empirical formula to predict acoustic performance of the muffler.

21. The process of claim 16, further comprising experimentally verifying the muffler design by installing a muffler produced according to the design into the computer system to verify whether the noise has been sufficiently reduced.

22. The process of claim 16, further comprising experimentally verifying the muffler design by testing a muffler produced according to the design outside the computer system by measuring the sound transmission loss of the muffler and comparing it to the target value.
